(19) United States
(12) Patent Application Publication
(10) Pub. No.: US 2003/0138201 A1
(43) Pub. Date: Jul. 24, 2003

(54) Self-aligned lens formed on a single mode optical fiber using CMP and thin film deposition

(75) Inventor: David G. Mikolas, Rowland Heights, CA (US)

Correspondence Address: Phyllis Turner-Brim, Cabot Microelectronics Corp., 870 Commons Drive, Aurora, IL, 60504, US

(73) Assignee: Cabot Microelectronics Corp.

(21) Appl. No.: 10/192,427

(22) Filed: Jul. 10, 2002

Related U.S. Application Data
(60) Provisional application No. 60/349,512, filed on Jan. 18, 2002.

(51) Int. Cl. G02B 6/32; G02B 6/02

(52) U.S. Cl. 385/33; 65/387; 385/123; 385/38

(57) ABSTRACT

Methods, including chemical mechanical polishing methods, for creating a focusing surface on the exposed end of one or more single mode fiber cores which focusing surface is self-aligned to the fiber core axis.

### BACKGROUND OF THE INVENTION

(1) Field of the Invention

This invention concerns methods for shaping the exposed end of a single mode fiber core to create a focusing surface that is self-aligned to the fiber core axis. The methods of this invention make it possible to manufacture single mode fibers with a wide range of focal lengths. This invention also includes single mode fibers with self aligning lenses.

(2) Description of the Art

Photonic Light Circuits (PLCs) with planar waveguides are becoming the preferred photonic processing medium for a large range of optical processing and communication systems. At the same time, optical fibers are used to transmit light from PLC to PLC when the distance between PLC's is greater than about 1 mm. A gap between the PLC's where the gap includes one or more focusing elements is usually specified in order to account for mechanical packaging and/or mode matching concerns.

A number of methods are used to manufacture focusing surfaces on the ends of the single mode optical fibers. However, the current methods do not eliminate the need for expensive manual manipulation and alignment of the single mode optical fibers. The present methods for manufacturing single-mode optical fibers also suffer from problems with product quality and uniformity. As a result, there is a need for a self-aligning single mode optical fibers and methods for manufacturing them.

### SUMMARY OF THE INVENTION

In one embodiment, this invention is a method for forming a focused lens on the end of a single mode fiber including a fiber core end having an exposed surface and a cladding material surrounding the core. The methods include removing a portion of the exposed surface of the fiber core to create a concave cavity in the exposed fiber core surface. A high index material is deposited on the surface of the fiber core in an amount sufficient to fill the concave cavity to form a fiber core having an exposed surface of high index material. At least a portion of the high index material layer is removed to form a lens on the fiber core end.

In another embodiment, this invention includes methods for forming a lens on the end of a single mode fiber including a fiber core having an exposed surface and a cladding material surrounding the core. The method includes removing a portion of the exposed surface of the fiber core to create a concave cavity in the exposed fiber core surface. A high index material is deposited on the surface of the fiber core in an amount sufficient to fill the concave cavity to form a fiber core having an exposed surface of high index material. A polishing composition is applied to the exposed surface of the fiber core, and at least a portion of the high index material is removed from the substrate by bringing a polishing substrate into contact with the exposed surface of the fiber core and thereafter moving the polishing substrate in relation to the exposed surface of the fiber core.

In still another embodiment, this invention includes methods for simultaneously forming a lens on the end of each of an plurality of single mode fibers.

In still another embodiment, this invention includes asingle mode fiber including a core having an end that includes a surface an a lens comprising a concave cavity in the core surface.

In a further embodiment, this invention includes A single mode fiber including a core including a core surface and having a lens comprising a concave cavity on the core surface that is filled with a high index material wherein the high index material has a surface that is planar with the core surface.

### DESCRIPTION OF THE FIGURES

FIGS. 1A-1D are side cross-section views of a single mode fiber undergoing various steps of an embodiment of a process of this invention wherein:

FIG. 1A is a side cross-section view of a single mode fiber (10) including a core (12), a cladding (14) and a jacket (16) prior to processing;

FIG. 1B is a side cross-section view of a single mode fiber including a concave cavity (18) formed into core (12);

FIG. 1C is a side cross-section view of a single mode fiber following deposition of a high index material layer (20) onto the exposed core surface;

FIG. 1D is a side-cross-section view of a single mode fiber following planarization of high index material layer (20) to form lens 21;

FIGS. 2A-2E are side cross-section views of a single mode fiber undergoing various steps of a process embodiment of this invention. The process steps shown in FIG. 2 are the same as shown in FIG. 1 except for step 2C in which an optional first antireflection material layer (22) is deposited onto the surface of the concave cavity prior to depositing a high index material layer 20 onto the exposed core surface.

FIGS. 3A-3G are side cross-section views of a single mode fiber undergoing various steps of a process embodiment of this invention. The process steps shown in FIG. 3 are the same as shown in FIG. 2 except for steps 3F and 3G in which an optional second antireflection (AR) material layer (24) is applied to the surface of the planarized high index material layer.

FIGS. 4A-4E are side cross-section views of a single mode fiber undergoing various steps of a process embodiment of this invention. The process steps shown in FIG. 4 are the same as shown in FIG. 2 except for the step shown in FIG. 4E in which the single mode fiber shown in FIG. 4F is overpolished to form a convex lens surface (28) on the single mode fiber core;

FIGS. 5A and 5B are top views of examples of single mode fiber arrays that can be processed according to the methods of this invention;

FIGS. 6A-6B are illustrations of a stigmatic lens fabricated onto the end of a single mode fiber using processes of this invention wherein FIG. 6A depicts the end of the single mode fiber and FIG. 6B is a profile of the X and Y cross-sections of the single mode fiber of FIG. 6A;

FIG. 7 is a plot of Gaussian half-widths of the envelope from the focusing lenses (25) illustrated in FIGS. 1D, 2E, and 3F where the envelope traces are shown for dishing depths (h) of 0.003, 0.01, 0.03, 0.1 and 0.3 microns wherein the distance at which each curve returns to the initial 3.3 micron half-width indicates theoretically where a second fiber end could be placed and still receive all of the light from the first fiber with high efficiency;

FIG. 8 is a cross-section of a positive meniscus lens that can be formed on the end of a single mode fiber by the methods of this invention;

FIG. 9 is a cross-section of a plano-convex lens that can be formed on the end of a single mode fiber by the methods of this invention; and

FIG. 10 is a cross-section of a bi-convex lens that can be formed on the end of single mode fiber by the method of this invention.

### DESCRIPTION OF THE CURRENT EMBODIMENT

This invention includes various methods for modifying the exposed end of a single mode fiber core to create a focusing surface or lens that is self-aligned to the fiber core axis. The methods of this invention make it possible to manufacture single mode fibers with ends that include a wide range of lenses of varying focal lengths. This invention also includes single mode fibers that are self-aligning to the single mode fiber cores as well as single mode fibers with a variety of lens surfaces including, but not limited to, plano-convex lenses, bi-convex lenses, meniscus lenses, positive meniscus lenses and so forth.

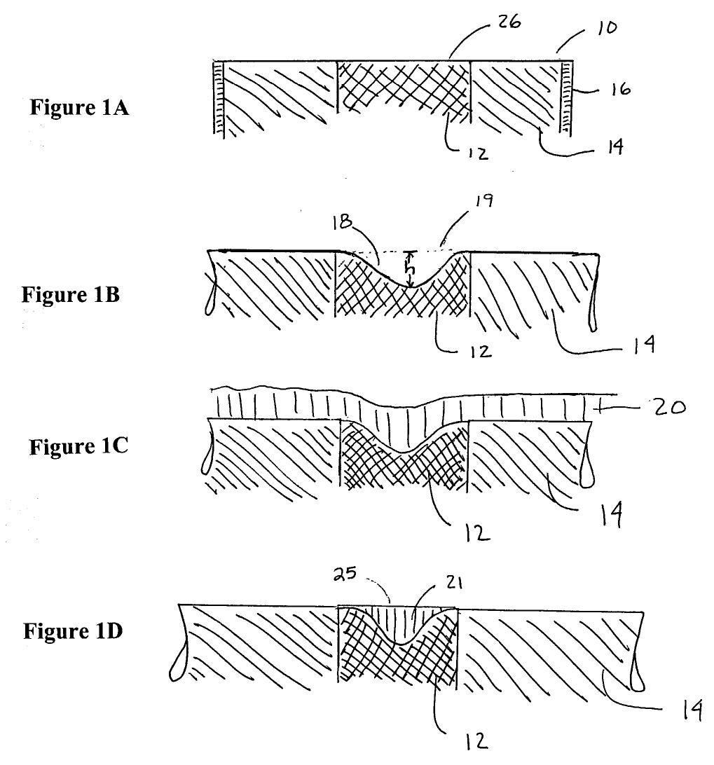

A cross section view of a single mode fiber 10 is shown in FIGS. 1A, 2A, 3A and 4A. Single mode fiber 10 includes a core 12, a cladding 14 surrounding core 12, and jacket 16 surrounding cladding 14. For most high performance fibers, jacket 16 is about 250 microns thick to prevent cladding 14 and core 12 from becoming nicked or cut and to insulate cladding 14 and core 12 from dramatic temperature changes.

Core 12 is a fiber element in which light is predominantly confined because of the slightly higher index refraction of the core material in comparison to the cladding material. The optical edge of core 12 is not always clearly delineated. The index of refraction of core 12 often falls off near the interface of the core 12 and cladding 14. In some very high performance fibers, annular rings of high index material are applied to the perimeter of core 12 to synthetically achieve this fall off.

Core 12 is typically manufactured from mixtures of light transparent or semi-transparent materials such as mixtures of silica (SiO₂) and germania (GeO₂). Other materials such as alumina (Al₂O₃) can be added to the mixture to tailor properties of core 12 such as index of refraction, chromatic dispersion, and thermo-optic coefficient. However core 12 may be manufactured from any material that is useful as a light transmitting material optics applications. Core 12 may be doped or undoped. Core 12 also may be coated with one or more materials to aid in the transmission of light through single mode fibers 10.

FIGS. 1A-1D depict an embodiment of a process of this invention for modifying the exposed end 26 of core 12 to create a focusing surface. In FIG. 1B, a portion of exposed end 26 of core 12 is removed to create a concave cavity 18. Concave cavity 18 has a depth “h” which is essentially equal to the distance from the deepest point of concave cavity 18 to the projection 19 of cladding 14. Concave cavity may be formed by any method that is capable of forming a concave cavity on surface 26 of core 12 including, but not limited to chemical etching, polishing, chemical mechanical planarization (CMP), laser ablation, and so forth. When CMP is used to form concave cavity 18, then the process should be performed in a manner that causes dishing of core material 12. Dishing is generally an undesirable CMP defect because the desired CMP surface is generally a planarized surface. Thus, even though chemical mechanical planarization is used in the process of this invention, the resulting and the desired core surface will not planar as is the case with CMP surfaces, instead, it will be concave in shape.

The desired level of dishing of core 12 can be achieved by modifying CMP variables such as polishing pad composition, polishing composition, and modifying polishing parameters such as back pressure, pad pressure and so forth. CMP techniques and variables are discussed in more detail below.

There are several unexpected advantages to using CMP to form concave cavity 18 in core 12. One advantage is that CMP is self-limiting in the present application. The further from cladding protection 19 that concave cavity 18 extends, the more difficult it is to remove additional material from the cavity by CMP techniques. The self-limiting aspect of CMP is due to the mechanics of the process and to the selected polishing composition. CMP polishing compositions typically include a chemical component that reacts with the exposed surface of the material being polished. The reaction softens the exposed surface and the softened surface material is removed by the abrasive action of the polishing pad and/or abrasive material against the softened surface. The softened surface also served as a passivation layer that protects unreacted subsurface core material from becoming solubilized or softened and from thereafter being removed from the core by etching. In a passive state essentially no further removal of the core material layer is possible without abrasion and, as concave cavity 18 becomes deeper and deeper, the polishing pad as used in the CMP process is not able to reach the passivation layer and it cannot be removed by the CMP. As a result, at some point in the CMP process, essentially no further material will be able to be removed from the concave cavity. A second important and unexpected feature of CMP on the fiber core is that it is reproducible. Because the polishing composition passivates a portion of the core material that is inaccessible to the polishing abrasive or polishing pad, the depth of concave cavity 18 can be reproduced for each similar single mode fiber core that is processed using the same CMP parameters.

In FIG. 1C, a high index material layer 20 is optionally deposited onto the surface of single mode fiber 10 to form high index material layer 20. High index material layer 20 should be deposited in an amount that is sufficient to fill concave cavity 18 and preferably overfill concave cavity 18 so that high index material layer 20 extends beyond the surface of cladding 14 as shown in FIG. 1C. It may be useful to overfill concave cavity 18 with high index material to facilitate surface planarization during the subsequent processing steps.

In FIG. 1D, the high index material layer is removed from the fiber cladding. High index material layer 20 is preferably removed by planarizing or by polishing and most preferably, high index material layer 20 is planarized by chemical mechanical planarization (CMP). The application of the planarizing process to high index material layer 20 as shown in FIG. 1D continues until all the high index material is removed from the surface of cladding 14 to form lens 25 at the end of core 12. In an alternative and less preferred embodiment, high index material layer 20 is incompletely removed from the surface of cladding 14.

The selection of high index material will depend upon the desired optical and thermo-mechanical properties of the core lens such as focal length radius of curvature, refractive high index of the core material, etc . . . . These factors will dictate the required refractive index of the high index material and the required refractive index will dictate the selection of the high index material. The high index material applied to the exposed end of single mode fiber 10 may be any material that has an index of refraction that is greater than the index of refraction of the core material. Preferably, the high index material has an index of refraction that is at least 20% greater than the index of refraction of the core and most preferably at least 30% greater than the index of refraction of the core.

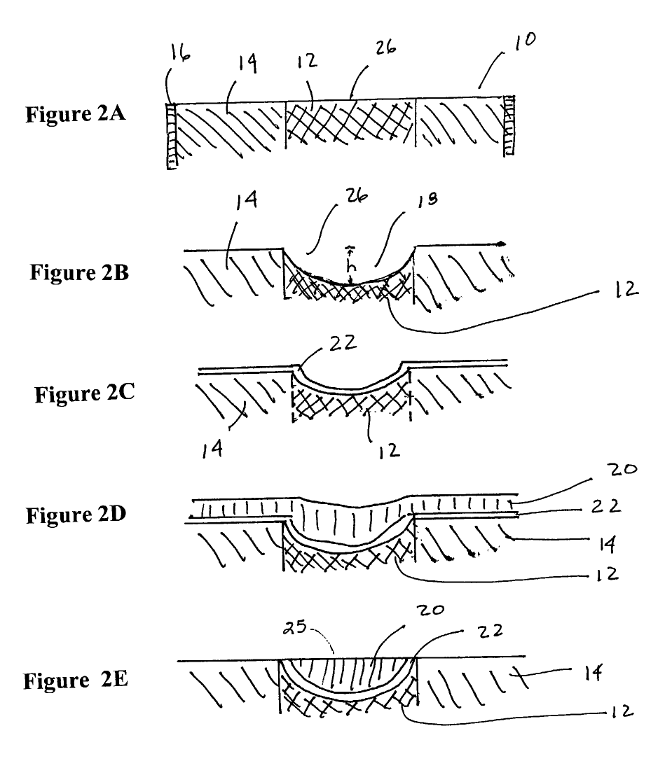

FIGS. 2A-2E depict an alternative embodiment of a process for forming a focusing surface on a single mode fiber. The process steps shown in FIGS. 2A-2E are essentially the same those shown in FIGS. 1A-1D and described above, except for the process step shown in FIGS. 2C. In FIG. 2C, a first antireflection (AR) material layer is applied to the exposed surface end 26 of single mode fiber 10 to form a very thin first antireflection material layer 22.

The use of an antireflection material will depend upon the refractive indexes of the core material and of the high index material. The greater the difference in the refractive index of the two materials, the greater the chance for reflection of light passing through the interface of the two materials. The antireflection material will be applied in situations where light reflection is a concern. The antireflection material can be a standard “quarter wave” coating or any other structure or material that provides an index match with the core material. In some cases, an antireflection material can be applied to the lens surface as opposed to the interface between the core material and the high index material. When an antireflection material is applied to the core surface, the antireflection material can be applied as a layer or it can be applied as a graded index structures such as arrays of very small cones or other microstructures spaced at distances less than a wavelength and having a height that does not exceed a wavelength. Such graded structures are applied to small surfaces using known photoresists and imaging techniques.

By far, the most common antireflection material is a quarter wave coating. The thickness of antireflection material coating will vary depending upon the index of refraction of the selected AR material. The following equations are used to calculate to approximate the thickness of the optional antireflection material coating. The index of refraction of the material in the quarter wave layer is the geometrical average of the index of refraction of the materials on either side. Thus if one side is 1.45 and the other side is 3.5, then the index of the quarter wave layer is:

n_{qw}≅sqrt(1.45*3.5)=2.25

With the wavelength of the quarter wave layer known, the thickness (t_{qw}) of the antireflection material layer is calculated using the following equation:

t_{qw}=λ₀/4*n_{qw}

where λ₀ is the wavelength in vacuum.

First antireflection material layer 22 should cover core 12 in concave cavity 18 such that the first antireflection material layer thickness does not exceed a thickness of about “t_{qw}” as defined above. Once first antireflection material layer 22 is formed, a high index material layer 20 is applied to the surface of single mode fiber 10 and a portion of the high index material is removed or planarized as described above with respect to FIGS. 1C-1D.

First antireflection material layer 22 can be applied to exposed surface 26 of single mode fiber 10 by a number of well know deposition method including, but not limited to, chemical vapor deposition, plasma enhanced chemical vapor deposition, thermal evaporation, electron beam evaporation, and physical vapor deposition.

The antireflection material will be a material that has the required refractive index as calculated by the equation identified above. Once the refractive index of the antireflection material layer is known, all that needs to be done is to select the material having the required refractive index from a list of optical compounds.

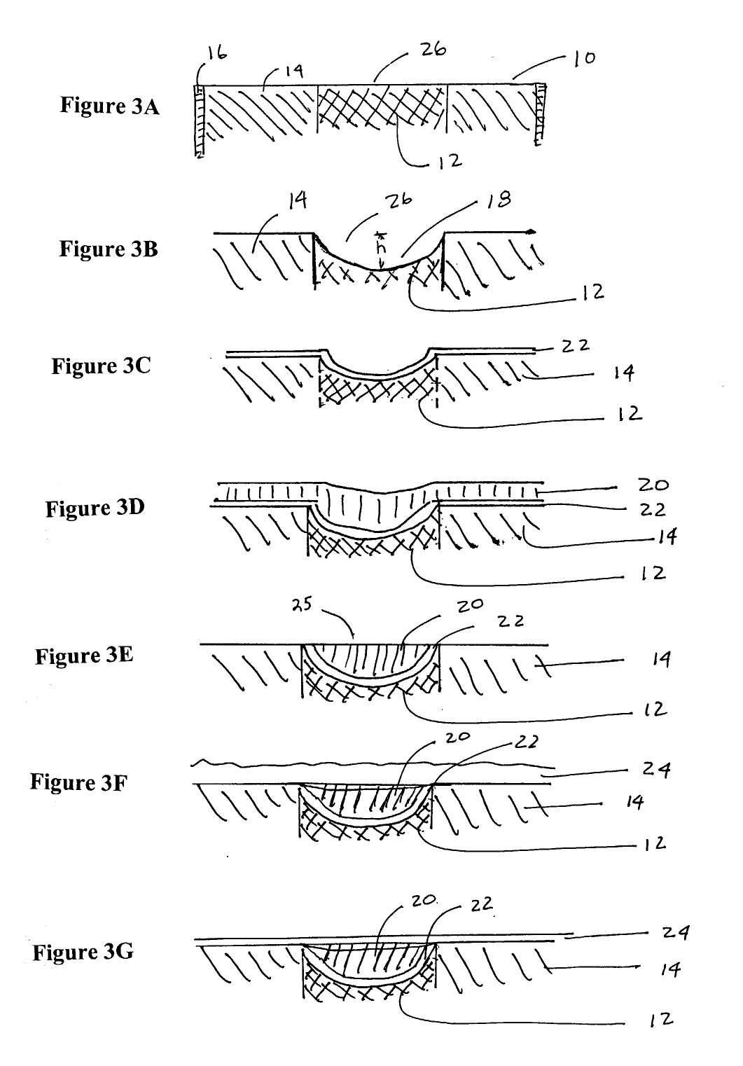

FIGS. 3A-3G depict yet another embodiment of a process of this invention for modifying the exposed end of fiber optic core to create a focusing surface. The steps shown in FIGS. 3A-3G are identical to the steps described in conjunction with FIGS. 2A-2E above. The added process steps, shown in FIGS. 3F and 3G, include applying a second antireflection material 24 to the surface of high index material layer 20 after removing at least a portion of the high index from high index material layer 20 as shown in FIG. 3E. Second antireflection material will be chosen based upon its required and calculated refractive index, from a table of optical materials. Second antireflection material layer 24 will have a thickness that is calculated in the same manner that is used to calculate the thickness of the first antireflection material layer 22.

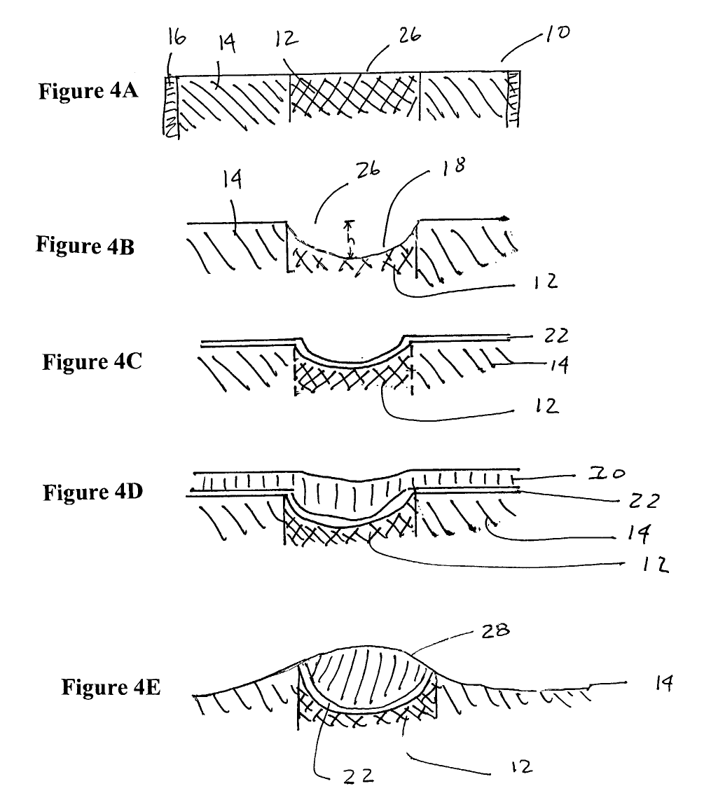

FIGS. 4A-4E depict yet another embodiment of the process of this invention. The process shown in FIG. 4 is identical to the process shown in FIG. 2 except for the addition of the processing step that results in the product shown in FIG. 4E. The single mode fiber end shown in FIG. 4E includes a bi-convex lens 28 that is prepared by polishing the surface of single mode fiber 10 including high index material layer 20 in a manner that preferentially removes cladding material 14 from single mode fiber 10 in comparison to high index material layer 20. The preferential removal of cladding material 14 from single mode fiber 10 can be performed by using polishing techniques or CMP techniques. Preferably, CMP techniques will be used to form a bi-convex lens 28 on the end of single mode fiber 10. In the preferred CMP technique, polishing parameters and/or polishing compositions that are selected towards the removal of cladding material 14, i.e., the cladding material polishes is removed at a faster rate than the core material, are preferred.

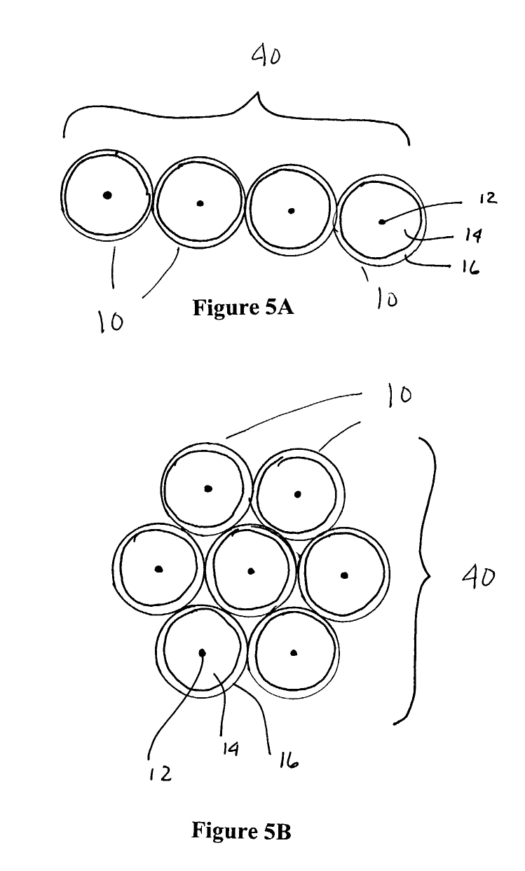

The processes described above may be performed on one single mode fiber 10 at a time or they can be performed on a plurality of single mode fibers simultaneously. FIGS. 5A and 5B depict two of many potential examples of polishing cassettes of single mode fibers. Typically, cassette 40 of single mode fibers will consist of a grouping of two more single mode fibers 10. Preferably, single mode fibers will be bundled together or held in cassette 40. Single mode fibers 10 can be reversibly or irreversibly secured in cassette 40. Additionally, cassette 40 can be designed to hold single mode fibers 10 in the same relative orientation that they will be used such as in a parallel orientation or in an angular orientation such that single mode fibers 10 do not need to be removed from the cassette after polishing and before use. Hold a plurality of single mode fibers in a cassette 40 allows for simultaneous processing of the surface of two or more single mode fibers by the processes of this invention to form focusing surfaces on each of the exposed single mode fiber core ends. In one embodiment of this invention, the plurality of single mode fibers will be glued or attached to one another in the same manner that they are ultimately used in a switch or circuit or some other device to allow for the simultaneous installation of a plurality of self-aligned single mode fibers simultaneously in the device in which the self-aligning single most fibers are used.

The high index material layers and antireflection material layers may be applied to the exposed ends of single mode fibers by any methods known in the art. Examples of useful deposition methods include sputtering, vapor deposition, chemical deposition, ion beam deposition and so forth.

The processes of this invention include the steps of removing material from core 12 to form concave cavity 18 and the optional removal of a portion of deposited high index material layer from the cladding surface. Any procedures that are known to those of skill in the art for controllably removing materials from a surface may be utilized in this invention. It is preferred, however, that polishing processes are used. The polishing process can be hand polishing or mechanical polishing processes with mechanical polishing processes preferred. The polishing processes can use a polishing substrate such as a cloth or a polishing pad alone or in conjunction with a liquid or aqueous polishing composition. It is most preferred that chemical mechanical planarization (CMP) techniques are used to remove at least one material or material layer from the exposed end of a single mode fiber during processes of this invention. For example, CMP techniques can be used to impart concave cavity 18 into core 12. CMP techniques may also be used to remove and planarize deposited high index materials layer 20. Finally CMP techniques can be used to preferentially remove cladding material 14 in comparison to core material 12 from the end of a single mode fiber core to create the bi-convex lens 28 shown in FIG. 4E.

In a typical chemical mechanical polishing (CMP) process, the substrate surface that is being polished is placed into contact with a rotating polishing pad. A carrier applies pressure against the backside of the substrate. During the polishing process, the pad and table are rotated while a downward force is maintained against the substrate back. A polishing composition is applied to substrate surface being polished. The polishing composition can be applied to the interface by applying the polishing composition to the polishing pad surface, to the substrate surface being polished or both. The polishing composition can be applied to the interface either intermittently or continuously and the application of the polishing composition can begin prior to or after the polishing pad is brought into contact with the substrate surface being polished. Finally, the term “applying a polishing composition” as it used in the specification and claims is not time limited and refers to the application of a polishing composition either before or after a polishing substrate is moved into contact with the surface being polished.

The polishing process further requires an abrasive material to assist in removing a portion of the substrate surface that has been softened by a reaction between the polishing composition and the substrate surface material. The abrasive may be incorporated into the polishing pad such as polishing pads disclosed in U.S. Pat. No. 6,121,143 which is incorporated herein by reference, it may be incorporated into the polishing composition, or both. Ingredients in the polishing composition or slurry initiate the polishing process by chemically reacting with the material on the surface of the substrate that is being polished. The polishing process is facilitated by the movement of the pad relative to the substrate as the chemically reactive polishing composition or slurry is provided to the substrate/pad interface. Polishing is continued in this manner until the desired film or amount of film on the substrate surface is removed.

The movement of the polishing pad in relationship to the substrate can vary depending upon the desired polishing end results. Often, the polishing pad substrate is rotated while the substrate being polished remains stationary. Alternatively, the polishing pad and the substrate being polished can both move with respect to one another. The polishing substrates and in particular the polishing pads of this invention can be moved in a linear manner, they can move in a orbital or a rotational manner or they can move in a combination of the directions. In some instances, it will be desirable to form a noncircular concave cavity in core 12 of single mode fiber 10. Noncircular concave cavities can be formed by for example moving the polishing pad in the x-direction to achieve the desired concave cavity parameters and then optionally moving the pattern in the y-direction until the desired convex cavity parameters are reached.

The polishing composition is formulated to include chemicals that react with and soften the surface of the material being polished. The choice of polishing composition or slurry is an important factor in the CMP step. Depending on the choice of ingredients such as oxidizing agents, film forming agents, acids, bases, surfactants, complexing agents, abrasives, and other useful additives, the polishing slurry can be tailored to provide effective polishing of the substrate layer(s) at desired polishing rates while minimizing surface imperfections, defects and corrosion and erosion. Furthermore, the polishing composition may be selected to provide controlled polishing selectivities to other thin-film materials used in substrate manufacturing.

Examples of CMP polishing compositions and slurries are disclosed, in U.S. Pat. Nos. 6,068,787, 6,063,306, 6,033,596, 6,039,891, 6,015,506, 5,954,997, 5,993,686, 5,783,489, 5,244,523, 5,209,816, 5,340,370, 4,789,648, 5,391,258, 5,476,606, 5,527,423, 5,354,490, 5,157,876, 5,137,544, 4,956,313, the specifications of each of which are incorporated herein by reference.

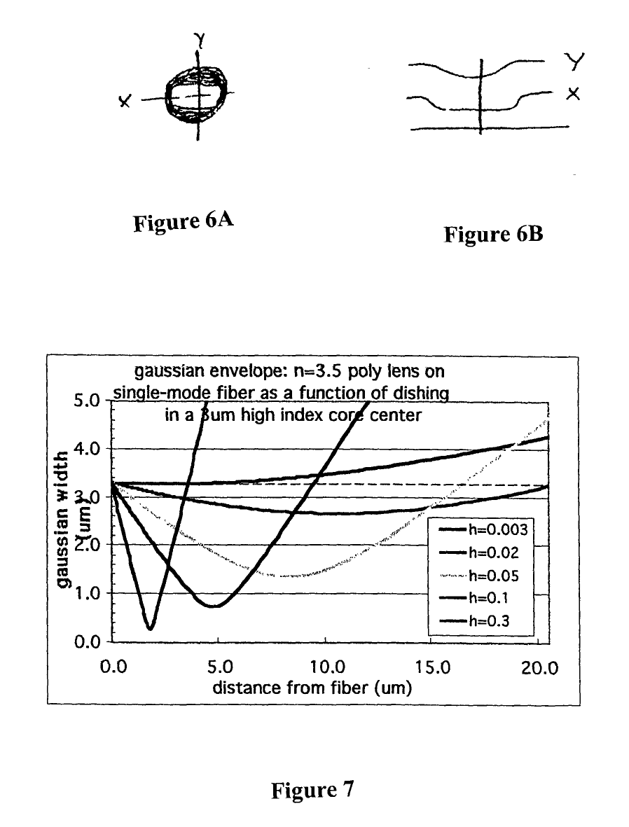

Self-aligning single mode fibers prepared by the method of this invention can include lens surfaces having a variety of shapes and features. FIG. 6 is an illustration of a stigmatic lens fabricated onto the end of a single mode fiber by the methods of this invention. The stigmatic lens shown in FIG. 6A is narrower in the y-direction than in the x-direction. Since depth in both directions is the same, the curvature in the y-direction is smaller (more strongly focusing) than in the x-direction. This effect can be used to bring the width of an optical beam envelope to a smaller size in one plane than the other—making a better match to the elongated mode of ridge wave guide of a semiconductor amplifier for example. FIG. 6B is a cross-section profile of the X and Y cross-sections of the single mode fiber end of FIG. 6A.

FIG. 7 is a plot of Gaussian half-widths as a function of distance (h) shown in FIG. 1B from the fiber surface. In the plot of FIG. 7, the half width of the envelope is shown as a function of distance outside the fiber for an amorphous silicon (n is equal to 3.5) plano-convex lens on a 6 micron single mode fiber core at a height h of from 0.003 to 0.3 microns.

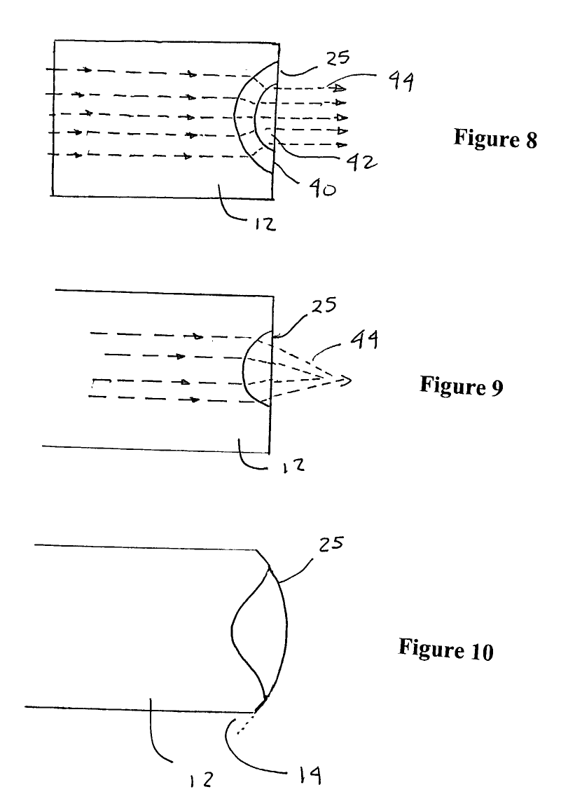

FIGS. 8-10 are examples of lenses that can be applied to the ends of single mode fibers by the methods of this invention to create self aligning single mode fibers. FIG. 8 is a cross-section of a positive meniscus lens that can be formed on the end of a single mode fiber by the methods of this invention. The positive meniscus lens is located in a low refractive index core material and includes a high index of refraction lens material portion 40 and an low index of refraction lens material portion 42. Light 44 passing through lens 25 is narrow and intensified by the lens. FIG. 9 is a cross-section of a plano-convex lens that can be formed on the end of a single mode fiber by the methods of this invention. Light 44 passing though the lens is focused at a location outside of core 12. FIG. 10 is a cross-section of a bi-convex lens that can be formed on the end of single mode fiber by the method of this invention that can also be designed to focus light outside of core 12.

While the present invention has been described by means of specific embodiments, it will be understood that modifications may be made without departing from the spirit of the invention. The scope of the invention is not to be considered as limited by the description of the invention set forth in the specification and examples, but rather as defined by the following claims.

What I claim is:

1. A method for forming a focused lens on the end of a single mode fiber including a fiber core end having an exposed surface and a cladding material surrounding the core comprising the steps of:
(a) removing a portion of the exposed surface of the fiber core to create a concave cavity in the exposed fiber core surface;
(b) depositing a high index material on the surface of the fiber core in an amount sufficient to fill the concave cavity to form a fiber core having an exposed surface of high index material; and
(c) removing at least a portion of the high index material layer to form a lens on the fiber core end.

2. The method of claim 1 wherein the high index material deposited in step (b) is higher than the height of the concave cavity.

3. The method of claim 1 wherein a layer of antireflection material is deposited onto the concave core surface prior to the deposition of the high index material in step (b).

4. The method of claim 3 wherein the antireflection material layer is a quarter wave coating.

5. The method of claim 1 wherein the step of removing a portion of the exposed surface of the fiber core to create a concave cavity is accomplished by chemical mechanical planarization.

6. The method of claim 5 wherein the chemical mechanical planarization comprises the further steps of:
(i) applying a polishing composition to the exposed surface of the fiber core; and
(ii) removing at least a portion of the metal layer from the substrate by bringing a polishing substrate into contact with the exposed surface of the fiber core and thereafter moving the polishing substrate in relation to the exposed surface of the fiber core.

7. The method of claim 6 wherein the polishing substrate is a fixed polishing pad.

8. The method of claim 7 wherein the polishing pad is a fixed abrasive polishing pad.

9. The method of claim 6 wherein the polishing composition includes abrasive particles.

10. The method of claim 6 wherein the polishing composition selectively polishes the core material over the cladding material.

11. The method of claim 1 wherein removal step (c) is accomplished by chemical mechanical planarization.

12. The method of claim 11 wherein the chemical mechanical planarization comprises the further steps of:
(i) applying a polishing composition to the exposed surface of the fiber core; and
(ii) removing at least a portion of the metal layer from the substrate by bringing a polishing substrate into contact with the exposed surface of the fiber core and thereafter moving the polishing substrate in relation to the exposed surface of the fiber core.

13. The method of claim 12 wherein the polishing substrate is polishing pad.

14. The method of claim 13 wherein the polishing pad is a fixed abrasive polishing pad.

14. The method of claim 12 wherein the polishing composition includes abrasive particles.

16. The method of claim 1 wherein a convex surface is applied to the core in polishing step (c).

17. The method of claim 1 wherein the fiber core of the single mode fiber is surrounded by a cladding material and wherein the high index material is applied to the fiber core surface and to the cladding surface.

18. The method of claim 17 wherein essentially all of the high index material applied to the cladding surface is removed during removal step (c).

19. A method for forming a lens on the end of a single mode fiber including a fiber core having an exposed surface and a cladding material surrounding the core, the method comprising the steps of:
(a) removing a portion of the exposed surface of the fiber core to create a concave cavity in the exposed fiber core surface;
(b) depositing a high index material on the surface of the fiber core in an amount sufficient to fill the concave cavity to form a fiber core having an exposed surface of high index material;
(c) applying a polishing composition to the exposed surface of the fiber core; and
(d) removing at least a portion of the metal layer from the substrate by bringing a polishing substrate into contact with the exposed surface of the fiber core and thereafter moving the polishing substrate in relation to the exposed surface of the fiber core.

20. The method of claim 19 wherein the step of removing a portion of the exposed surface of the fiber core to create a concave cavity in the exposed fiber core surface is accomplished by the further steps of:
(i) applying a polishing composition to the exposed surface of the fiber core; and
(ii) removing at least a portion of the metal layer from the substrate by bringing a polishing substrate into contact with the exposed surface of the fiber core and thereafter moving the polishing substrate in relation to the exposed surface of the fiber core.

21. The method of claim 19 wherein a plurality of single mode fibers are held in a cassette and wherein a lens is simultaneously applied to each single mode fiber core surface.

22. A method for forming a lens on the end of each of an plurality of single mode fibers comprising the steps of:
(a) bundling at least two single mode fibers together in a cassette wherein at least two single mode fibers include exposed cores and wherein the surfaces of at least two of the single mode fibers are essentially planar;
(b) removing a portion of the exposed surface of at least two single mode fiber cores to form a concave cavity on the exposed surface of each fiber core;
(c) depositing a high index material into the concave cavity of at least two of the fiber cores wherein the high index material is deposited in an amount sufficient to fill the concave cavities to form a plurality of fiber cores having exposed surfaces of high index material; and
(d) planarizing the surface of the high index material wherein removal step (b) and planarizing step (d) are each accomplished by the further steps of:
(i) applying a polishing composition to the exposed surface of the fiber core; and
(ii) removing at least a portion of the metal layer from the substrate by bringing a polishing substrate into contact with the exposed surface of the fiber core and thereafter moving the polishing substrate in relation to the exposed surface of the fiber core.

23. A single mode fiber including a core having an end that includes a surface an a lens comprising a concave cavity in the core surface.

24. The single mode fiber of claim 23 wherein the lens is a concave cavity that is filled with a high index material.

25. The single mode fiber of claim 24 wherein the high index material has a surface that is essentially planar with the core surface.

26. The single mode fiber of claim 24 wherein the lens is a plano-convex lens, a bi-convex lens, a meniscus lenses, or a positive meniscus lens.

27. A single mode fiber including a core including a core surface and having a lens comprising a concave cavity on the core surface that is filled with a high index material wherein the high index material has a surface that is planar with the core surface.
